(19) United States
(12) Patent Application Publication
(10) Pub. No.: US 2015/0170461 A1
(43) Pub. Date: Jun. 18, 2015

(54) GAMING DEVICE HAVING MULTI-REEL SYMBOLS

(71) Applicant: KING SHOW GAMES, INC., Minnetonka, MN (US)

(72) Inventors: Bradley BERMAN, Minnetonka, MN (US); Nathan WODARZ, Eagan, MN (US)

(21) Appl. No.: 14/563,969

(22) Filed: Dec. 8, 2014

Related U.S. Application Data
(60) Provisional application No. 61/916,091, filed on Dec. 13, 2013.

(51) Int. Cl. G07F 17/32; G07F 17/34

(52) U.S. Cl. CPC G07F 17/3213; G07F 17/34

(57) ABSTRACT

Embodiments of the present invention set forth systems, apparatuses and methods for implementation of multi-reel symbols in gaming devices. Accordingly, a gaming device can be configured to receive a game initiation signal and determine reels associated with a multi-reel symbol. This configuration includes initializing the multi-reel symbol within the reels or otherwise initializing game elements associated with a multi-reel symbol. A game outcome is then determined incorporating the initialized multi-reel symbol or game elements. This game outcome is displayed to a player via a display associated with the gaming device, and awards associated with the game outcome are provided.

### RELATED APPLICATIONS

This application claims the benefit of Provisional Patent Application No. 61/916,091, filed on Dec. 13, 2013, to which priority is claimed pursuant to 35 U.S.C. §119(e) and which is incorporated herein by reference in its entirety.

### FIELD OF THE INVENTION

This disclosure relates generally to games, and more particularly to systems, apparatuses and methods for implementing multi-reel symbols on gaming devices.

### BACKGROUND

Casino games such as poker, slots, and craps have long been enjoyed as a means of entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementation of multi-reel symbols in gaming devices. In one embodiment, a gaming device includes a display, a player interface, and a processor. The processor may be configured to receive a game initiation signal and determine reels associated with a multi-reel symbol. The processor may further be configured to initialize the multi-reel symbol within the reels and determine a game outcome. The reels may be spun on the display under control of the processor, and then stopped to show the determined game outcome of the display. The processor may then be configured to determine prizes associated with the game outcome.

### BRIEF DESCRIPTION OF THE DRAWINGS

FIG. 1 is a diagram of a gaming machine according to embodiments of the invention.

FIG. 2 is a detail diagram of a game display showing multi-reels symbols according to embodiments of the invention.

FIGS. 3A, 3B, 3C, and 3D are diagrams of a game display showing a progression of game play with a multi-reel symbol according to embodiments of the invention.

FIG. 4 is a flow diagram of a method of operating a gaming device to implement multi-reel symbols according to embodiments of the invention.

FIG. 5 is a diagram of a reel offset locking procedure to implement multi-reel symbols according to embodiments of the invention.

FIG. 6 is a flow diagram of a reel offset locking procedure to implement multi-reel symbols according to embodiments of the invention.

FIGS. 7A, 7B, 7C, and 7D are diagrams of a game display showing another progression of game play with a multi-reel symbol according to embodiments of the invention.

FIGS. 8A, 8B, 8C, and 8D are diagrams of a game display showing another progression of game play with a multi-reel symbol according to embodiments of the invention.

FIG. 9 is a flow diagram of a method of operating a gaming device to implement multi-reel symbols according to embodiments of the invention.

FIG. 10 is a block diagram illustrating a computing arrangement according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the term “reels,” “cards,” “decks,” and similar mechanically descriptive language may be used to describe various apparatus presentation features, as well as various actions occurring to those object (e.g., “spin,” “draw,” “hold,” “bet”). Although the present disclosure may be applicable to both to manual, mechanical, and computerized embodiments, and any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

As used in this disclosure, the term “multi-reel symbol” may be used to describe a symbol that spans over two or more game reels. The terms “multi-symbol reel” and “block symbol” may also be used interchangeably in this description. For example, in a traditional video slot game with five vertical reels that spin, a two-reel block symbol would be a symbol that was partially on both of reels 1 and 2, reels 2 and 3, reels 3 and 4, or reels 4 and 5 (although possible embodiments could also include a block symbol that wrapped around from reel 5 to reel 1). Other multi-reel symbols may be three-reel, four-reel, 5-reel, etc. block symbols that span more than two reels. In yet other variations, the locked reels need not be adjacent. For instance, in a 5 reel game, reels 1, 3, and 5 may be locked. In this case a block symbol would contain a gap or gaps.

For evaluation purposes, each position of a block symbol may be treated as an independent symbol of a similar type to the symbol shown on the block symbol, in some embodiments. For example, in a 2×2 block symbol that shows a wild symbol, the four symbol positions associated with the block symbol may each be evaluated as a separate wild symbol. In other embodiments, a block symbol may be evaluated as being a single symbol. In yet other embodiments, a block symbol may have a special evaluation process, such as by acting as a multiplier or bonus credit trigger.

Generally, systems, apparatuses and methods are described for enhancing winning result opportunities in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot machine game) are provided for purposes of facilitating an understanding of the features described herein. However, the principles described herein are equally applicable to any game of chance where an outcome(s) is determined for use in the player's gaming activity. The game features described herein may be employed in stand-alone games, a primary/base games, bonus games, side bet games, etc.

Embodiments of the present concept include providing gaming devices (also referred to as gaming apparatuses or gaming machines), gaming systems, and methods of operating these devices or systems to provide game play that implement multi-reel symbols in a gaming device. In one embodiment, a method of operating a gaming device includes a process of inserting multi-reel symbols into independent reels. That is, the independent reels may be spun individually during some of the game play, but may be connected to each other in order to facilitate a block symbol being placed within the two or more reels. One method of accomplishing this is to lock the designated reels together and insert a block symbol within the locked reels prior to spinning the reels. Although the block symbol may not appear in the final game result when the reels are stopped, evidence or animation of the block symbol may be seen during the spinning of the reels.

In some embodiments this process may include the following steps:
1. Begin with a set of reel strips, of which some subcollection(s) will be chosen to be locked together. These reels may be of the same length to help ensure the blocks are positioned on existing symbol positions on the reel strip. In other embodiments, algorithms may be used to ensure that blocks fit within reels of varying lengths.
2. Select the locked reels. This may be done by weighted random selection. For example, up to three adjacent reels may be locked into one reel to spin in some embodiments. Any given reel will either spin independently or will be in a locked reel grouping.
3. Once the reels to be locked together are chosen, it is determined where to lock the reels together. This may be done by either specifying an offset or by taking one randomly on each reel. For example, if Reels 3 and 4 are to be locked together and offsets 12 and 45 are respectively specified for the reels, a new locked reel is created where offsets 12 and 45 are at the top (locked offset 0), 13 and 46 are in the second position (locked offset 1), and so on.
4. Next the blocks for insertion may be determined. Here, each block may specify three items:
   a. Where the insertion is to take place (the reel and offset of the upper left corner of the block).
   b. The height and width of the block. Blocks may have any specified height and width. In some embodiments, blocks may have a width of one to accommodate certain predefined patterns of reel locks.
   c. The symbol to be shown on the block. This may be chosen from a weighted random selection from all symbols appearing in that portion of the game. The symbol need not appear on the reels prior to insertion.
Although the above process specifies that blocks are inserted into locked reels, other embodiments include processes where blocks are inserted into independent reels. These independent reels may then be subsequently locked or may be spun independently with the block coordinated to a predetermined symbol location. For example, the upper left corner of the block may be the controlling position of the block which controls the display and result of the block when reels are independently spun.
5. Sort the blocks by offset from least to greatest.
6. Insert the blocks in order, pushing all symbols on the affected reels at or below the offset down by the appropriate height for each block. In other embodiments, the symbols at the insertion point of the block may simply be replaced by the portions of the block symbol.

In an example that uses the above process, reels 2, 3, and 4 are locked together. A 2×2 block wild symbol is to be inserted into the locked reel with upper corner located at reel 3, offset 38. All positions on the reels above offset 38 are left alone. Additionally, Reel 2 is left untouched at this step. If the block symbol is a wild symbol, the block wild symbol will be located on Reels 3 and 4 at offsets 38 and 39. The symbol previously located in these positions will be pushed to offsets 40 and 41 respectively.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of similar techniques in other types of poker games, slot games, or other games of chance. Some of these other types of embodiments will be discussed below as variations to the examples illustrated. However, many other types of games can implement similar techniques and fall within the scope of this inventive concept.

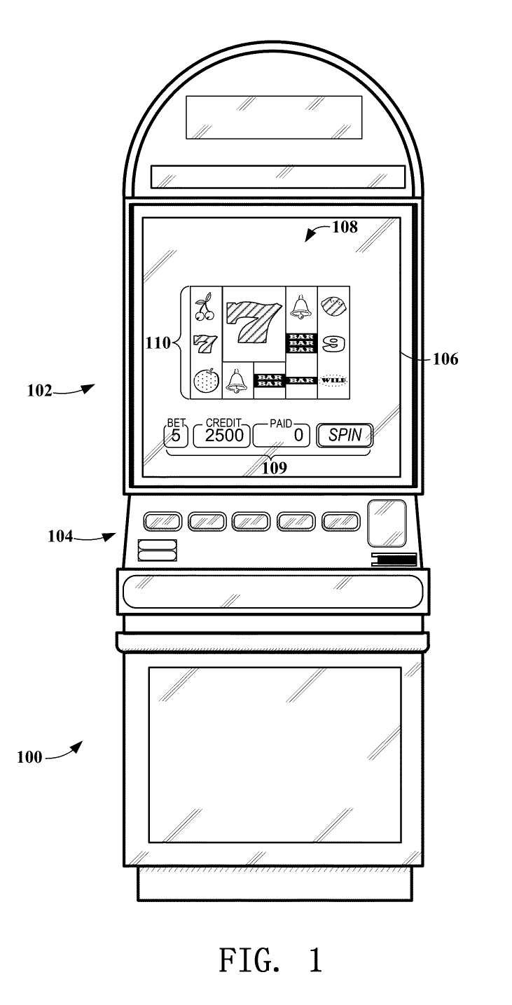

Referring to the example gaming apparatus 100 shown in FIG. 1, the gaming apparatus includes a display portion 102 (also referred to as a gaming display), and a player interface portion 104, although some or all of the user interface 104 may be provided via the display 102 in touch screen embodiments. The display portion 102 may include one or more display areas 106 that may be included in physically separate displays or as portions of a common large display. Here, the game display 106 includes a game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are known in the art. For example, coin/symbol input mechanisms, card readers, credit card readers, smart card readers, punch card readers, radio frequency identifier (RFID) readers, and other mechanisms may be used to enter wagers. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The display device 102 may include one or more of an electronic display, a mechanical display, and a fixed display information, such as paytable information associated with a glass/plastic panel on the gaming machine 100. The symbols or other indicia associated with the play of the game may be presented on an electronic display device or on mechanical devices associated with a mechanical display. Generally, the display 102 devotes the largest portion of viewable area to the primary gaming portion 106. The gaming portion 106 is generally where the visual feedback for any selected game is provided to the user. The gaming portion 106 may render graphical objects such as cards, slot reels, dice, animated characters, and any other gaming visual known in the art. The gaming portion 106 also typically informs players of the outcome of any particular event, including whether the event resulted in a win or loss.

In some of the example embodiments illustrated herein, the gaming portion 106 may display a grid 108 (or equivalent arrangement) of reel stop positions. The grid 108 may also be associated with paylines that pass through multiple reel stop positions in the grid to define position combinations associated with awards.

In the illustrated grid 108, five reels are shown with three reel stop positions visible for each reel. Hence, in this embodiment the grid 108 is a 5×3 grid (i.e., five symbols wide by 3 symbols high). Although, the grid 108 is shown on a video display 102 in this embodiment, the grid could also be implemented on a display that included physical reels that mechanically spin.

The gaming portion 106 may include other features known in the art that facilitate gaming, such as status and control portion 109. As is generally known in the art, this portion 109 provides information about current bets, current wins, remaining credits, etc. associated with gaming activities of the grid 108. The control portion 109 may also provide touchscreen controls for facilitating game play. The grid 108 may also include touchscreen features, such as facilitating spinning of the reels, stopping of the reels, or wager placement. The gaming portion 106 of the display 102 may include other features that are not shown, such as paytables, navigation controls, etc.

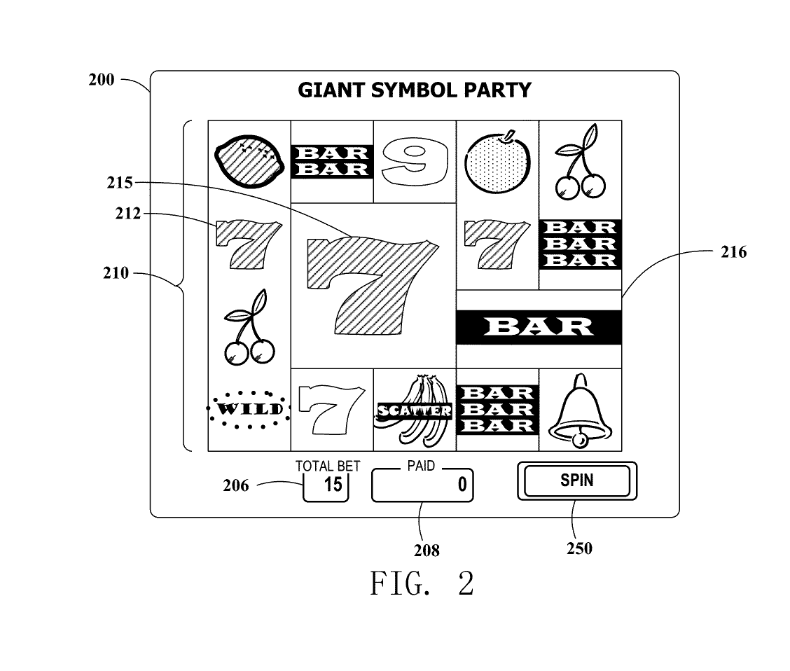

FIG. 2 is a detail diagram of a game display 200 having a 5×4 gaming grid 210 along with game meters 206, 208 and a player interface button 250. The gaming grid 210 includes five independent reels that each have four reel stop positions visible as part of a game outcome. Game symbols 212 populate the reel and form the reel strips associated with each reel in the game device. Although five continuous reels are shown in this embodiment, each reel stop position may have its own independent reel strip associated with it in other embodiments.

The game grid 210 of the game display 200 also illustrates two multi-reel symbols 215, 216. Block symbol 215 is a 2×2 symbol that spans reels 2 and 3. Block symbol 216 is a 2×1 symbol that spans reels 4 and 5. As discussed above, block symbols may of any size that fit within the game reels. In some embodiments, the presence of the block symbol 215 on reels 2 and 3 means that reels 2 and 3 are locked together. Likewise, the presence of the block symbol 216 on reels 4 and 5 would mean that reels 4 and 5 are also locked together. Thus, during a subsequent reel spin, reel 1 would spin independently, reels 2 and 3 would spin and stop together, and reels 4 and 5 would spin and stop together.

In other embodiments, the reels to be locked together may be selected prior to inserting the block symbols. For example, in the embodiment shown in FIG. 2, it may have been initially selected that reels 2, 3, 4, and 5 were to be locked together. The next step may have determined certain block symbols that appear on two or more of reels 2, 3, 4, and 5. If this was the case, reel 1 would spin independently, and reels 2, 3, 4, and 5 would spin together even though the blocks 215 and 216 do not span all of the previously indicated locked reels.

In yet other embodiments, locked reels could be separated prior to spinning if the inserted blocks did not span the entire portions of the locked reels. In the above example, even though reels 2, 3, 4, and 5 were originally locked together for placement of block symbols, since the only inserted blocks spanned reels 2 and 3, and reels 4 and 5 without overlap, the locked reels 2, 3, 4, and 5, may be separated into locked reels 2 and 3 and locked reels 4 and 5 prior to spinning. This may also be the case if no blocks were selected to be inserted into a designated locked reel pattern. For example, if reels 2, 3, 4, and 5 were selected to be locked, but no block symbols were inserted, each reel 1, 2, 3, 4, and 5 may be spun independently in the subsequent game.

In still other embodiments, reels 1, 2, 3, 4, and 5 would be spun independently even though block symbols were to be inserted as shown in FIG. 2. Here, the upper left corner of the block, or another location, could be used as an anchor location for the block. Prior to the reels stopping, substantially contemporaneously with the reels stopping, or after the reels stop the block symbol may be displayed relative to the anchor position of the block symbol. This display may include replacing symbols adjacent to the anchor symbol that are covered by the insertion of the block symbol, or these adjacent symbols may be displaced downward on the respective reels.

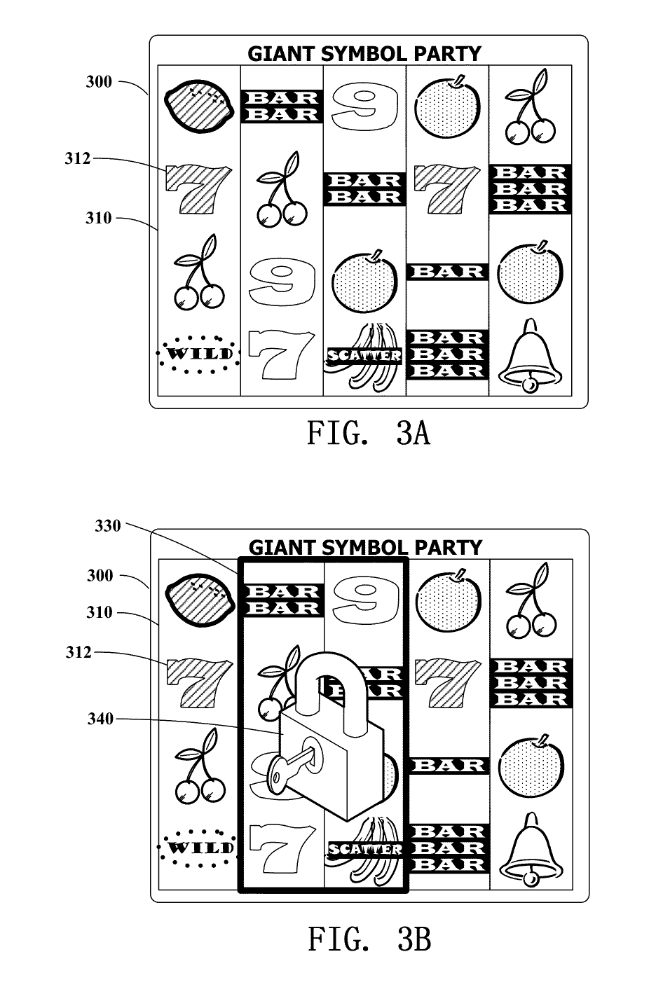

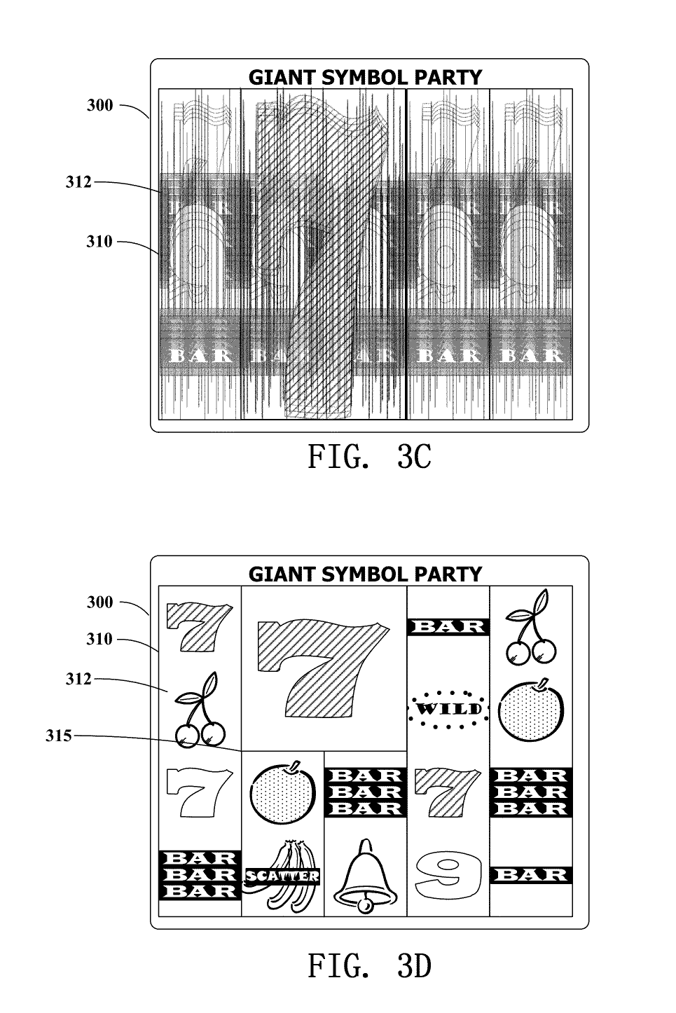

FIGS. 3A-3D illustrate one example game progression to illustrate implementation methods of multi-symbol games. Referring to FIG. 3A, a game display 300 may initially show game reels 310 with a 5×4 grid of game symbols on five reels. In FIG. 3B, a locking process may be shown by highlighting the locked reels 330 (here reels 2 and 3) and/or providing a locking animation 340 or other indication of the reels being locked. In FIG. 3C, the reels are spun. Here, it is evident from the spinning animation that reels 2 and 3 are locked and that a block symbol (a shaded-7) is present on those locked reels. In FIG. 3D, the reels have come to a rest, and a block symbol 315 is shown in the game result.

As discussed above, for evaluation purposes, the game may treat each symbol position associated with the block symbol as an independent symbol, or may treat the entire block symbol as a single symbol. Thus, in the result shown in FIG. 3D, the shaded-7 block symbol 315 may be evaluated as four independent shaded-7 symbols. This would thereby create a number of 3-symbol pays, or 4-symbol pays (using the “wild” on reel 4) to award to the player. Alternatively, the block symbol 315 may be treated as a single symbol, but have a special property such as acting as a “5×” multiplier. In such as example, the shaded-7 block symbol may be used to create a 3-symbol pay using the shaded-7 symbol on the first reel and the wild symbol on the fourth reel to create a 3-symbol combination win, which is then multiplied by “5×” because the block symbol was used in the paying symbol combination. Many other evaluation techniques and variations are also possible.

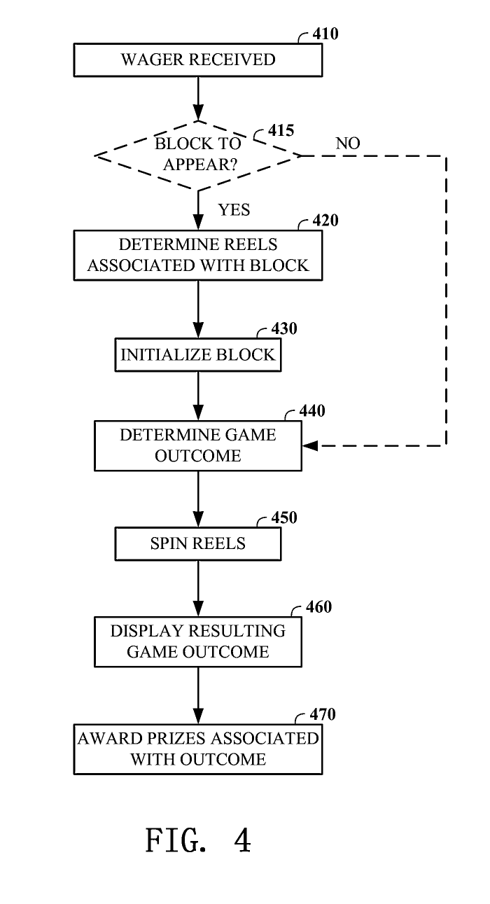

FIG. 4 is a flow diagram of a method of operating a gaming device to implement multi-reel symbols according to embodiments of the invention. Although various processes are shown in a particular order in this flow diagram, the order of these processes can be changed in other embodiments without deviating from the scope or spirit of this concept. Hence, the order of the processes shown is for illustrative purposes only and is not meant to be restrictive. Additional game processes may also be included between various processes even though they are not shown in these flow diagrams for clarity purposes. Further each of the processes may be performed by components in a single game device, such as by a game processor, or may be performed in part or whole by a remote server or processor connected to the gaming device via a network. Each process may be encoded in instructions that are stored in a memory, a computer-readable medium, or another type of storage device.

Note that this example method is just one embodiment of how a game operation can be implemented. As discussed and shown above, many variations exist which may require additional, less, or different processes to complete.

Referring to FIG. 4, a wager is received in process 410 to initiate a game (although a game could be initiated in other ways, such as an automatic trigger in a free game bonus). In optional process 415, it is determined if a block is to appear. Here, there may be an initial random determination to see if a subsequent slot game or group of slot games will include a block symbol. This random determination may utilize a weighted table or other technique to determine the likelihood of a block appearing. If a block is not determined to appear, the flow proceeds to process 440 where a game outcome is determined. If a block is to be inserted in the game, the flow proceeds to process 420 where it is determined which reels are associated with a block.

In process 420, it may be determined which reels are to be locked together, as described above. This may involve the selection of a reel locking pattern, which is discussed in more detail below. In other embodiments where the reel as not locked together, process 420 may include determining an anchor position for the block symbol, determining the size of the block, and identifying which reels will be affected by the implementation of the block symbol. In process 430, the block is initialized. In some embodiments, process 430 may include determining if a block is to appear in the locked reels. If a block is determined to be included, process 430 may further determine which of the locked reels will be associated with the blocks by determining the characteristics of the block, such as one or more of its size, insertion point, reel offset, associated symbol, etc. In other embodiments where the reels are not locked, process 430 may include associating the determined block information with the determined anchor position of the block symbol.

Once the block is initialized, the game outcome may be determined in process 440. In some embodiments, the game outcome may be determined prior to the initialization of the block in process 430, or another process may be included to determine symbols that will be replaced or displaced on reels adjacent to a determined anchor point for the block symbol. The reels are spun in process 450, and the determined game outcome is displayed in process 460. The game outcome is then evaluated and prizes are awarded for any symbol combinations present in the game outcome that are reflected in a paytable in process 470.

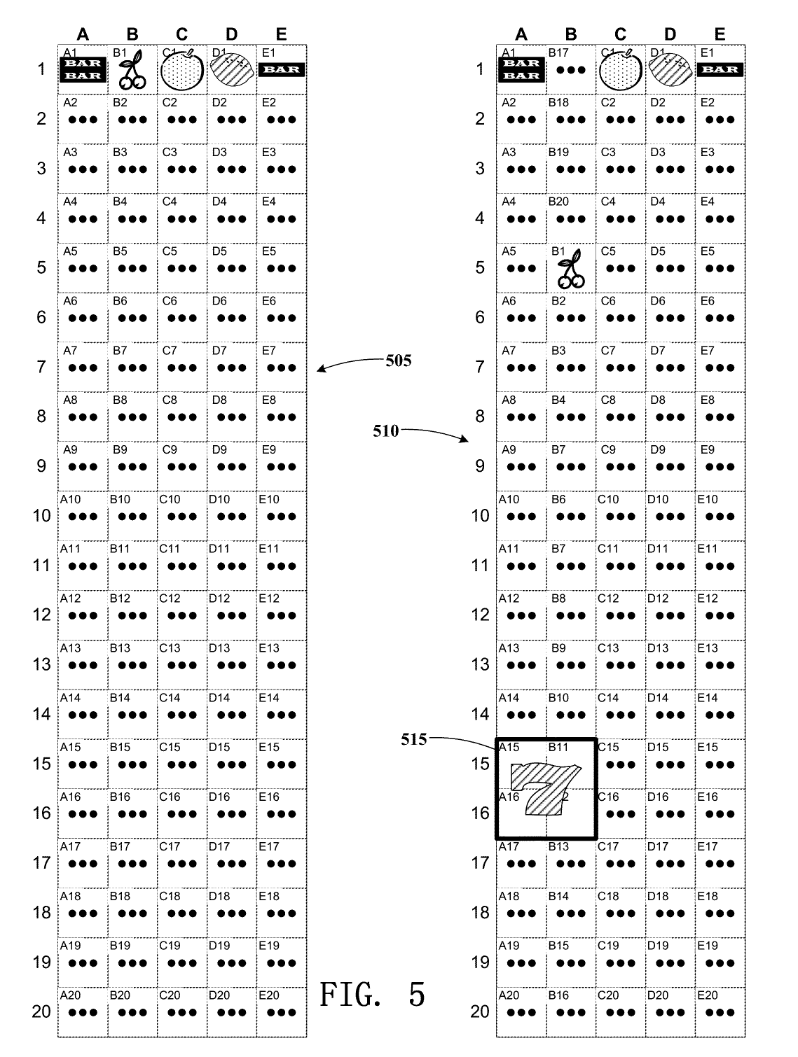

FIG. 5 is a diagram of a reel offset locking procedure to implement multi-reel symbols according to embodiments of the invention. Referring to FIG. 5, a representative set of reels is shown by element 505. Here, each reel position on each reel strip is associated with a symbol. Each of the five reels is designated with an identifier such as “A,” “B,” “C,” “D,” and “E.” The stop positions on each reel are further labeled by position 1-20. Note that reels may be of any length and that reel positions indicators may start at “0” instead of “1.” Each of the “ . . . ” indicators is meant to show a reel symbol. However, since the specific symbol is not important for purpose of this explanation, they are shown generically with the “ . . . ” indication.

Element 510 illustrates an example where reels 1 and 2 (reels “A” and “B”) are indicated as being locked together. A block symbol 515 is initialized with an insertion point and offset that corresponds to reels 1 and 2. Here, a 2×2 symbol has been selected to be inserted with its upper left corner at 15^{th} position of reel 1, and reel 2 is offset by 4 prior to being locked to reel 1. Note that in this example, the inserted block symbol replaces the symbols underlying it in the reel strip. However, in other embodiments, as discussed above, the insertion of a block symbol can displace the affected reel symbols down two positions. Thus, none of the original symbols on a reel are replaced.

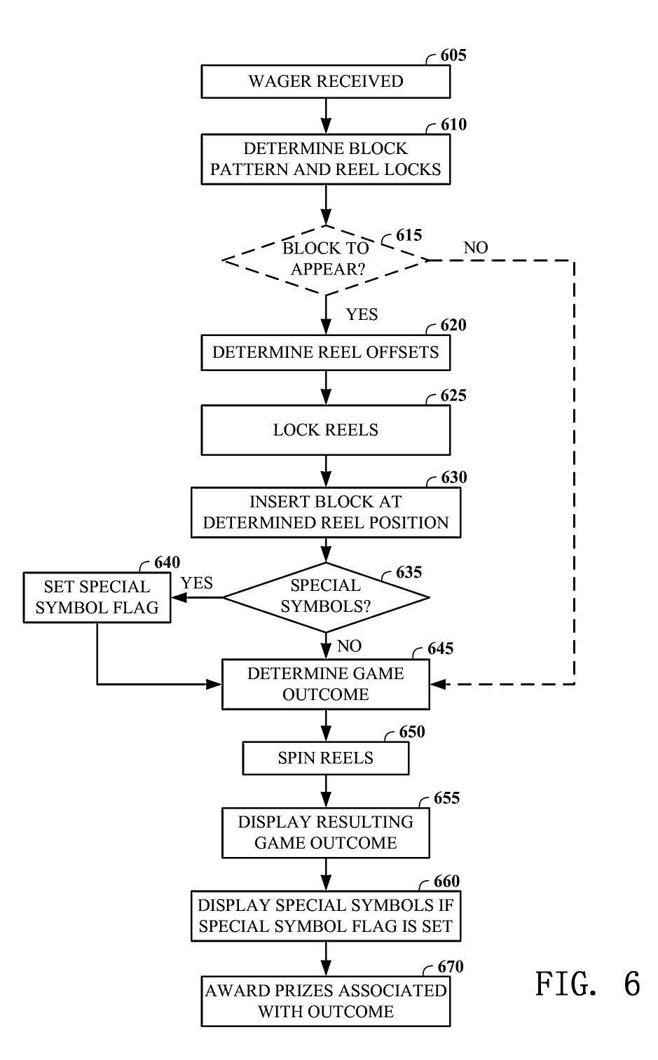

FIG. 6 is a flow diagram of a reel offset locking procedure to implement multi-reel symbols according to embodiments of the invention. Referring to FIG. 6, a wager is received in process 605 and a block pattern and reel lock designation is determined in process 610. Here, reels may be selected to be locked together from multiple predetermined reel locking patterns. For example, if a game is to have up to 3 reels locked together, it may specify a number of possible reel locking patters, such as 1-1-1-2, 1-1-2-1, 1-2-1-1, 2-1-1-1, 3-1-1, 1-3-1, 1-1-3, 2-1-2, 1-2-2, 2-2-1, 1-3-1, 2-3, 3-2, and 1-1-1-1-1 where each pattern indicates the reels to be locked together. Note that in this example, the 1-1-1-1-1 pattern would mean that no reels are locked together. In other embodiments, the reels to be locked together may be chosen independently of any designated patterns.

In optional process 615, it is determined if a block is to appear. Here, there may be an initial random determination to see if a subsequent slot game or group of slot games will include a block symbol. This random determination may utilize a weighted table or other technique to determine the likelihood of a block appearing in the locked reels. If a block is not determined to appear, the flow proceeds to process 645 where a game outcome is determined. Even though a reel lock pattern may be determined, if a block is not determined to appear in process 615, the reels may remain unlocked and spin independently of each other. If a block is to be inserted in the game, the flow proceeds to process 620 where it is determined what the reel offsets are for the locking reels.

In process 625, the indicated reels are locked at the offsets specified in process 620. In process 630, blocks are selected and inserted into the locked reels according to the processes discussed above. In embodiments where the block symbols replace existing symbols on the reel strips, process 635 is performed to see if any specially indicated symbols are being replaced by the block symbol. Special symbols may include bonus triggering symbols, scatter symbols, wild symbols, or other specified symbols. These symbols may influence particular game characteristics or payback percentages and thus need to be accounted for. If any special symbols are determined to be replaced by an inserted block symbol in process 635, and special symbol flag is set in process 640.

The flow then proceeds to process 645 where a game outcome is determined. The reels are spun in process 650 and the resulting game outcome is displayed in process 655. The special symbols replaced by the block symbol may be shown as part of a symbol position in process 660 when the special symbol flag is set. This may be accomplished by alternating between displaying the special symbol and the portion of the block symbol, or by creating a sub-symbol or split symbol where both the special symbol and block symbol are included in the same reel stop position. Prizes are then awarded in process 670 for any symbol combinations appearing in the evaluated game outcome that correspond to a paytable.

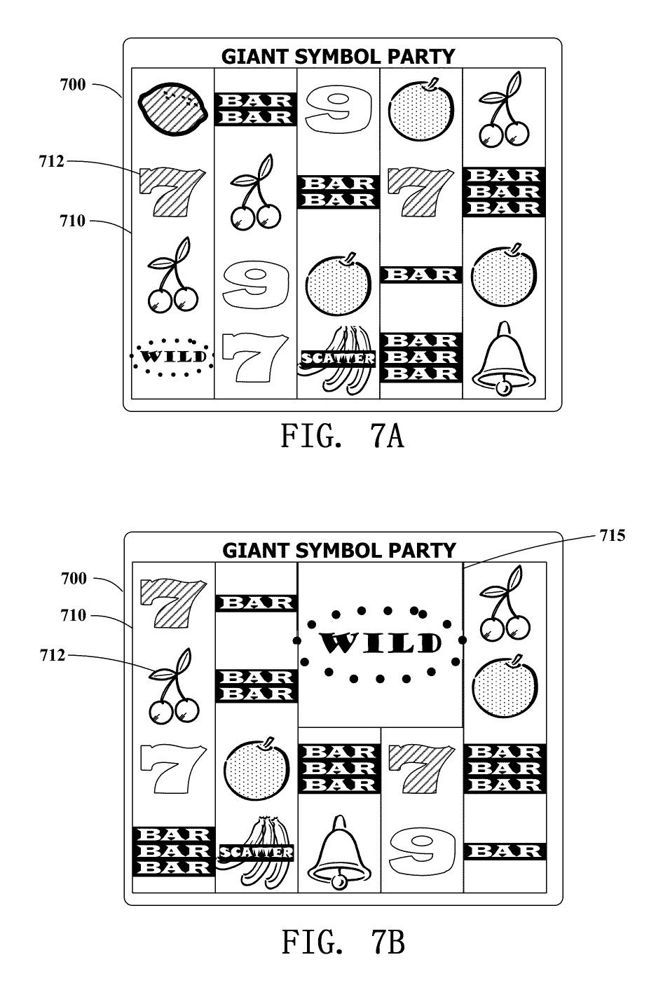

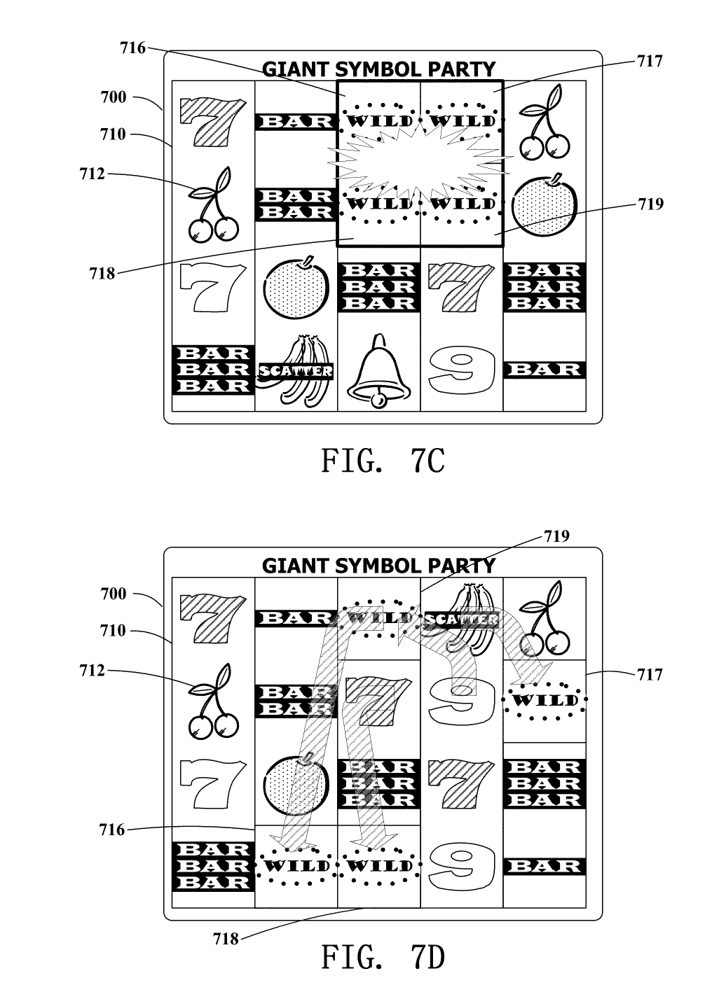

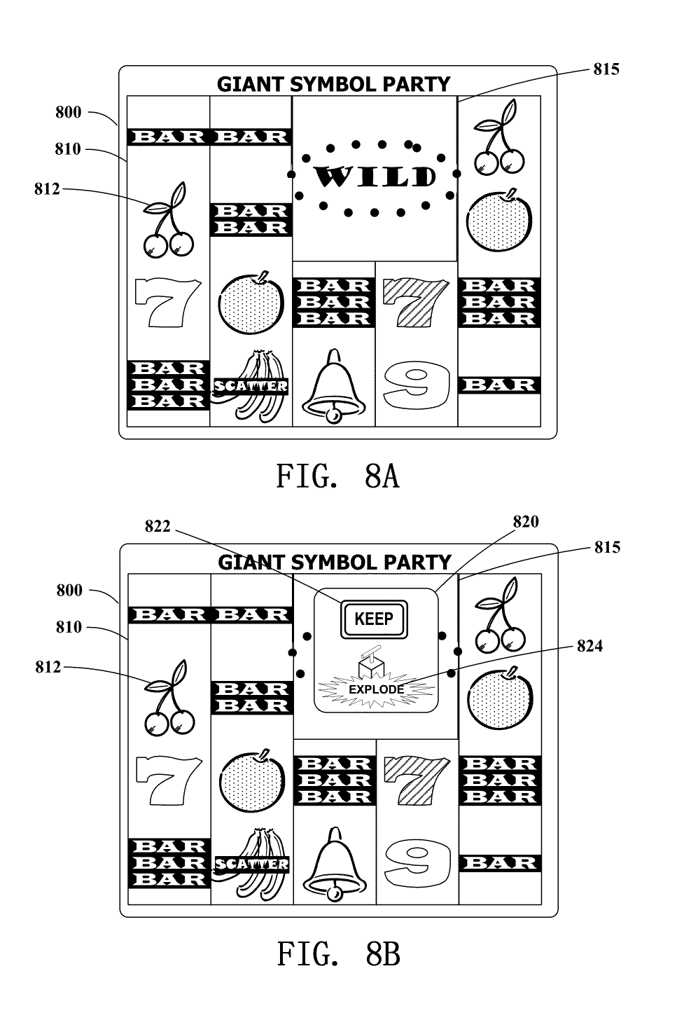

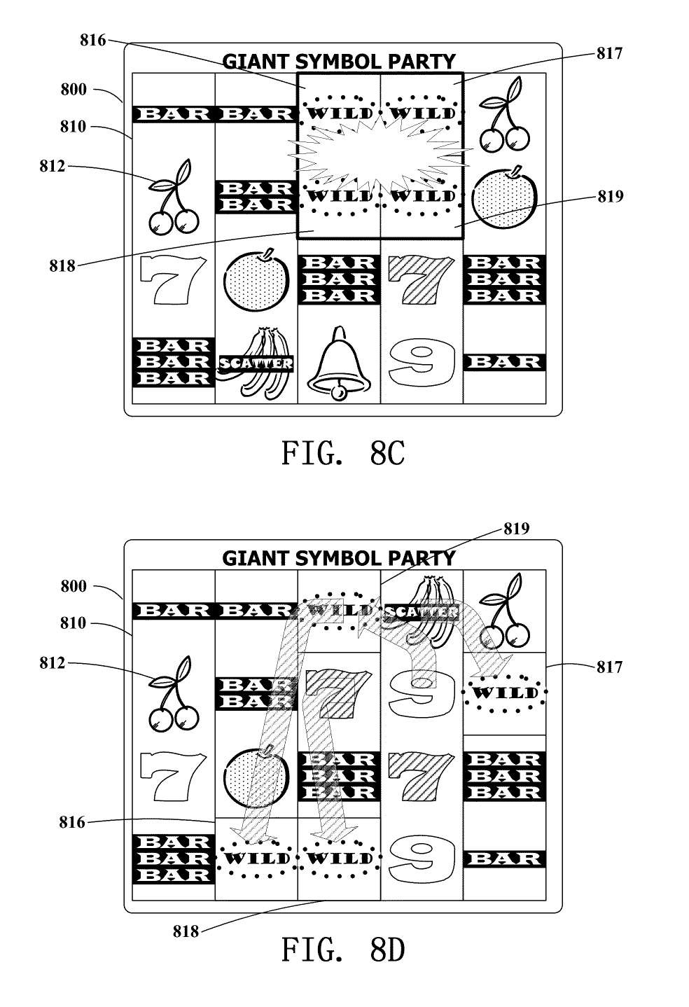

FIGS. 7A-7D and FIGS. 8A-8D illustrate example game progressions where the block symbols that appear on the display can or will explode and scatter individual symbols associated with the particular symbol of the block symbol to other reel stop positions. This works especially well with wild symbols or other symbols having special properties. In the game progression shown in FIGS. 7A-7D, the block symbol automatically explodes after it lands on the game grid. The game grid is evaluated after the explosion to determine prizes and awards. Awards may be evaluated and paid prior the explosion in some embodiments. In the game progression shown in FIGS. 8A-8D, the player is given the choice of whether to explode the block symbol or take the outcome evaluation with the symbol in block form.

Referring to FIGS. 7A-7D, a game display 700 includes reels 710 with individual symbols 712 in symbol positions on the reel strips. As shown in FIG. 7B, after a game is played a block wild symbol is shown on reels 3 and 4. Although the block wild symbol does not initially look like it is going to be helpful in creating winning symbol combinations, it then explodes, as shown in FIG. 7C, and the resulting four wild pieces 716, 717, 718, 719 are scattered on the game grid 710. This explosion may happen every time a block symbol appears, or may only occur randomly. The positions of the resulting symbol “pieces” 716, 717, 718, 719 may be determined at random, may be determined by what locations provide the best award (optimum locations), or may be determined according to another process. FIG. 7D shows the result of the wild pieces 716, 717, 718, 719 being scattered by the explosion in FIG. 7C. In some embodiments, the symbols under the block symbol may be symbols of the reel strip that were initially replaced by the block symbol. In other embodiments, the symbols under the exploded block symbol may be individual symbols corresponding to the block symbol. In yet other embodiments, the symbols positions where the exploded block symbol pieces 716, 717, 718, 719 land are converted into split symbols or other multi-symbols that show both the original symbol and the symbol from the exploded block piece.

Referring to FIG. 8A-8D, a game display 800 includes reels 810 with individual symbols 812 and a block symbol 815. In FIG. 8B, the player is prompted to select whether to keep the block or explode it. This window prompt 820 may include a “KEEP” or stay/hold button 822, which may indicate an award total if the player elects to keep the block, and an explode button 824, which may be used to explode the block symbol 815. As shown in FIGS. 8C and 8D, the player in this example progression has elected to explode the block. This choice gives up a 4 symbol combination of single bar symbols in the hopes of better paying symbol combinations by having the block pieces 816, 817, 818, 819 scattered over the game grid 810.

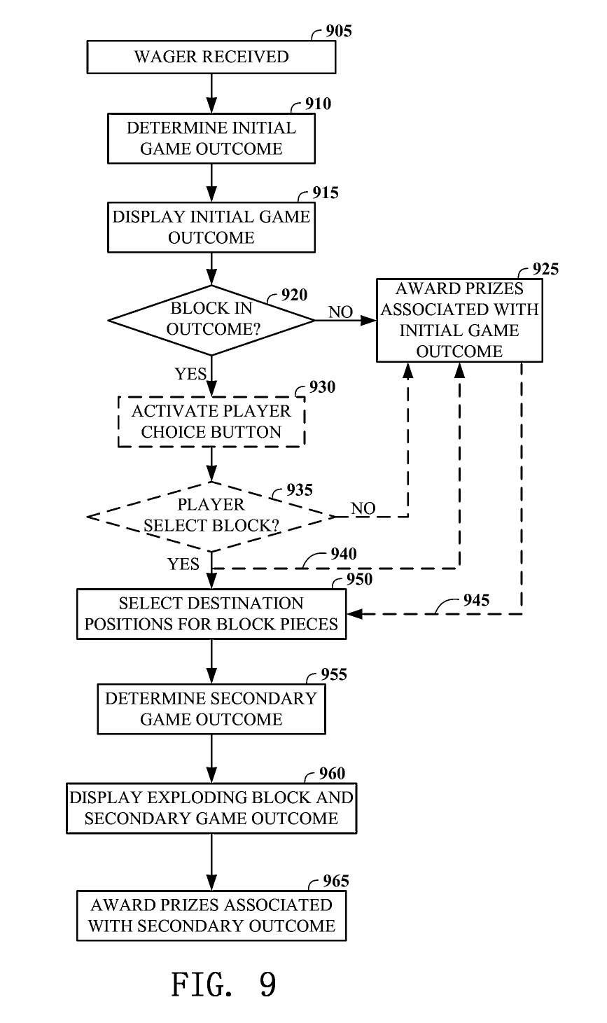

FIG. 9 is a flow diagram of a method of operating a gaming device to implement multi-reel symbols that can explode according to embodiments of the invention. Referring to FIG. 9, a flow begins at process 905 where a wager is received. In process 910, an initial game outcome is determined. In process 915, the initial game outcome is displayed. It is then determined if a block symbol is part of the displayed game outcome in process 920. If no block symbol is present, the flow proceeds to process 925 where the initial game outcome is evaluated and awards for symbol combinations associate with the initial game outcome are provided to the player. If a block symbol is present in the game outcome as determined in process 920, the flow proceeds to optional process 930 where a player choice button is provided (similar to the embodiments shown in FIGS. 8A-8D). Following this optional process, the flow proceeds to optional process 935, where it is determined if the player selected the block to explode. If the player has chosen not to explode the block, the flow proceeds to process 925 where the initial game outcome is evaluated and awards for symbol combinations associate with the initial game outcome are provided to the player. If the player has chosen to explode the block (or the block is automatically exploded as shown in FIGS. 7A-7D), the flow can optionally evaluate and pay for the initial game outcome along flow 940 and return via flow 945 to process 950, or proceed directly to process 950 without evaluating the initial game outcome.

In process 950 the destination positions for the pieces of the block are determined. A secondary game outcome is then determined in process 955 using the determined destination positions for the block pieces. In process 960, the block is shown exploding and the resulting game outcome with the block pieces in the determined destination positions is shown. In process 965, the secondary game outcome is evaluated and prizes associated with symbol combinations corresponding to entries in a paytable are awarded.

The embodiments discussed above are primarily related to slot machine games. However, this concept can be applied to a variety of games of chance played on gaming devices.

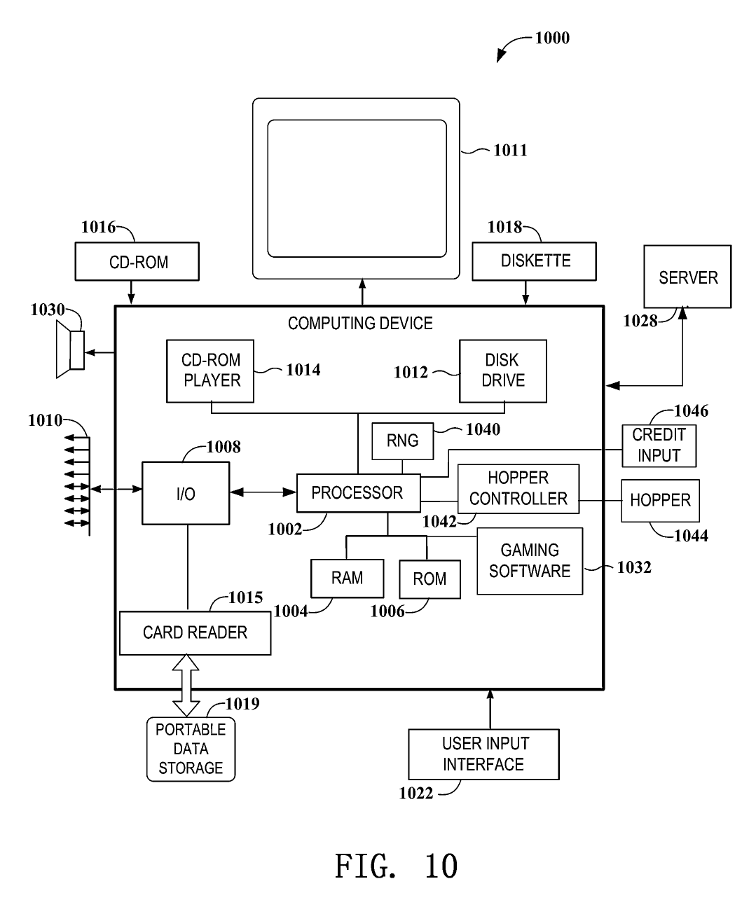

As may now be readily understood, one or more devices may be programmed to play various embodiments of the invention. The present invention may be implemented as a casino gaming machine or other special purpose gaming kiosk as described hereinabove, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 10.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 1000 of FIG. 10 is an example computing structure that can be used in connection with such electronic gaming machines, computers, or other computer-implemented devices to carry out operations of the present invention.

The example computing arrangement 1000 suitable for performing the gaming functions in accordance with the present invention typically includes a central processor (CPU) 1002 coupled to random access memory (RAM) 1004 and some variation of read-only memory (ROM) 1006. The ROM 1006 may also represent other types of storage media to store programs, such as programmable ROM (PROM), erasable PROM (EPROM), etc. The processor 1002 may communicate with other internal and external components through input/output (I/O) circuitry 1008 and bussing 1010, to provide control signals, communication signals, and the like.

The computing arrangement 1000 may also include one or more data storage devices, including hard and floppy disk drives 1012, CD-ROM drives 1014, card reader 1015, and other hardware capable of reading and/or storing information such as DVD, etc. In one embodiment, software for carrying out the operations in accordance with the present invention may be stored and distributed on a CD-ROM 1016, diskette 1018, access card 1019, or other form of computer readable media capable of portably storing information. These storage media may be inserted into, and read by, devices such as the CD-ROM drive 1014, the disk drive 1012, card reader 1015, etc. The software may also be transmitted to the computing arrangement 1000 via data signals, such as being downloaded electronically via a network, such as the Internet. Further, as previously described, the software for carrying out the functions associated with the present invention may alternatively be stored in internal memory/storage of the computing device 1000, such as in the ROM 1006.

The computing arrangement 1000 is coupled to the display 1011, which represents a display on which the gaming activities in accordance with the invention are presented. The display 1011 represents the “presentation” of the video information in accordance with the invention, and may be any type of known display or presentation screen, such as liquid crystal displays, plasma displays, cathode ray tubes (CRT), digital light processing (DLP) displays, liquid crystal on silicon (LCOS) displays, etc.

Where the computing device 1000 represents a stand-alone or networked computer, the display 1011 may represent a standard computer terminal or display capable of displaying multiple windows, frames, etc. Where the computing device is embedded within an electronic gaming machine, the display 1011 corresponds to the display screen of the gaming machine/kiosk. A user input interface 1022 such as a mouse, keyboard/keypad, microphone, touch pad, trackball, joystick, touch screen, voice-recognition system, etc. may be provided. The display 1011 may also act as a user input device, e.g., where the display 1011 is a touchscreen device.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs as known in the art may be implemented using hardware, software operable in connection with the processor 1002, or some combination of hardware and software. The present invention is operable using any known RNG, and may be integrally programmed as part of the processor 1002 operation, or alternatively may be a separate RNG controller 1040.

The computing arrangement 1000 may be connected to other computing devices or gaming machines, such as via a network. The computing arrangement 1000 may be connected to a network server 1028 in an intranet or local network configuration. The computer may further be part of a larger network configuration as in a global area network (GAN) such as the Internet. In such a case, the computer may have access to one or more web servers via the Internet. In other arrangements, the computing arrangement 1000 may be configured as an Internet server and software for carrying out the operations in accordance with the present invention may interact with the player via one or more networks.

Other components directed to gaming machine implementations include manners of gaming participant payment, and gaming machine payout. For example, a gaming machine including the computing arrangement 1000 may also include a hopper controller 1042 to determine the amount of payout to be provided to the participant. The hopper controller may be integrally implemented with the processor 1002, or alternatively as a separate hopper controller 1042. A hopper 1044 may also be provided in gaming machine embodiments, where the hopper serves as the mechanism holding the coins/tokens of the machine. The wager input module 1046 represents any mechanism for accepting coins, tokens, coupons, bills, electronic fund transfer (EFT), tickets, credit cards, smart cards, membership cards, etc., for which a participant inputs a wager amount. It will be appreciated that the primary gaming software 1032 may be able to control payouts via the hopper 1044 and controller 1042 for independently determined payout events.

Among other functions, the computing arrangement 1000 provides an interactive experience to players via input interface 1022 and output devices, such as the display 1011, speaker 1030, etc. These experiences are generally controlled by gaming software 1032 that controls a primary gaming activity of the computing arrangement 1000. The gaming software 1032 may be temporarily loaded into RAM 1004, and may be stored locally using any combination of ROM 1006, drives 1012, media player 1014, or other computer-readable storage media known in the art. The primary gaming software 1032 may also be accessed remotely, such as via the server 1028 or the Internet.

The primary gaming software 1032 in the computing arrangement 1000 is shown here as an application software module. According to embodiments of the present invention, this software 1032 provides a slot game or similar game of chance as described hereinabove. For example, the software 1032 may present, by way of the display 1011, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 1032 may include instructions to provide other functionality as known in the art and described herein, such as shown and described above regarding FIGS. 1-9.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a display including a video screen having a game play grid showing portions of a plurality of independent game reels;
a player interface including at least one button, the button configured to generate a signal in response to being activated;
a wager input device structured to identify and validate currency or currency based tickets;
secured circuitry operable to generate random numbers; and
game circuitry operable to:
receive a game initiation signal,
determine if two or more game reels are to be locked together,
determine a game reel offset for at least one of the reels to be locked together,
lock the game reels determined to be locked together, where the relative reel positions of the locked reels are based on the determined game reel offset,
determine block characteristics for a block symbol to be inserted in the game reels,
insert the block symbol with the determined block characteristics into the locked game reels,
determine a game outcome,
spin game reels on the display,
display the determined game outcome in the game play grid of the display,
evaluate the determined game outcome to identify winning symbol combinations, and
provide awards associated with any identified winning symbol combinations.

2. The gaming device of claim 1, wherein the game circuitry is further operable to determine if a block symbol is to be inserted prior to inserting a block symbol into the locked game reels.

3. The gaming device of claim 2, wherein the game circuitry is further operable to unlock the locked reels when it is determined that a block symbol is not to be inserted into the locked game reels.

4. The gaming device of claim 1, wherein the game circuitry is operable to determine if two or more game reels are to be locked together by determining a reel lock pattern from a plurality of predefined reel lock patterns.

5. The gaming device of claim 1, wherein the game circuitry is operable to determine if two or more game reels are to be locked together by randomly selecting reels to lock together if any.

6. The gaming device of claim 1, wherein the game circuitry is operable to determine block characteristics for the block symbol to be inserted by determining at least one of a block size, a symbol associated with the block, and a reel insertion location for the block.

7. The gaming device of claim 1, wherein the operation of the game circuitry to evaluate the determined game outcome to identify winning symbol combinations includes evaluating the block symbol as a plurality of independent symbols.

8. The gaming device of claim 1, wherein the operation of the game circuitry to evaluate the determined game outcome to identify winning symbol combinations includes evaluating the block symbol as a single symbol.

9. The gaming device of claim 1, wherein the operation of the game circuitry to evaluate the determined game outcome to identify winning symbol combinations includes associating an outcome modifier with the block symbol.

10. The gaming device of claim 9, wherein the operation of the game circuitry to associated an outcome modifier with the block symbol includes associating a multiplier with the block symbol.

11. The gaming device of claim 1, wherein the game circuitry is operable to insert the block symbol into the locked game reels by determining an insertion location in the locked reels and replacing existing symbols in the game reels with the block symbol.

12. The gaming device of claim 11, wherein the operation of the game circuitry to insert the block symbol into the locked game reels further includes setting a special symbol flag when an existing symbol to be replaced meets a predefined criterion.

13. The gaming device of claim 1, wherein the game circuitry is operable to insert the block symbol into the locked game reels by determining an insertion location in the locked reels and displacing existing symbols in the game reels with the block symbol by lengthening the game reels and moving the displaced existing symbols downward in the game reels.

14. The gaming device of claim 1, wherein the game circuitry is further operable to randomly disperse portions of the block symbol to other game play grid locations when at least a portion of the block symbol is displayed on the game play grid as part of the displayed game outcome.

15. The gaming device of claim 14, wherein the game circuitry is further operable to evaluate the game outcome after the portions of the block symbol have been dispersed to the different game play grid locations.

16. The gaming device of claim 14, wherein the game circuitry is further operable to request a player input to confirm the random dispersion of the portions of the block symbol prior to dispersing the portions of the block symbol, wherein the portions of the block symbol are maintained in their current locations if a player input is received indicating a declination of the block symbol portion dispersion.

17. A gaming device comprising:
a display including a video screen having a game play grid showing portions of a plurality of independent game reels;
a player interface including at least one button, the button configured to generate a signal in response to being activated;
a wager input device structured to identify and validate currency or currency based tickets;
secured circuitry operable to generate random numbers; and
game circuitry operable to:
receive a game initiation signal,
determine if a block symbol is to be inserted in the game reels,
determine an anchor position for the block symbol within the game reels,
determine block characteristics for a block symbol to be inserted in the game reels,
determine a game outcome,
independently spin game reels on the display,
display the block symbol on the game reels based on the determined anchor position and determined block characteristics,
display the determined game outcome in the game play grid of the display,
evaluate the determined game outcome to identify winning symbol combinations, and
provide awards associated with any identified winning symbol combinations.

18. The gaming device of claim 17, wherein the operation of the game circuitry to determine an anchor position for the block symbol includes identifying a location in the games reels representative of an upper left corner of the block symbol.

19. A gaming system connected to a game display operable to display a game play grid showing portions of a plurality of independent game reels and a player interface operable to receive player inputs, the gaming system including circuitry operable to perform processes comprising:
receiving a game initiation signal;
determining if a block symbol is to be inserted in the game reels;
determining block characteristics for the block symbol when it is determined that the block symbol is to be inserted in the game reels, wherein the determined block characteristics includes a determination of which game reels will contain the block symbol;
determining a game reel offset for at least one of the reels that will contain the block symbol;
locking the game reels determined to contain the block symbol, where the relative reel positions of the locked reels are based on the determined game reel offset;
inserting the block symbol with the determined block characteristics into the locked game reels;
determining a game outcome;
transmitting a signal to the game display to initiate a spin sequence for the game reels;
transmitting a signal to the game display to display the determined game outcome in the game play grid of the game display;
evaluating the determined game outcome to identify winning symbol combinations; and
providing awards associated with any identified winning symbol combinations.

20. The gaming system of claim 19, wherein the gaming system circuitry is housed in a secure server, and wherein the game display is a housed in a remote terminal connected to the secure server via a network.
